(19) United States
(12) Patent Application Publication
(10) Pub. No.: US 2009/0256451 A1
(43) Pub. Date: Oct. 15, 2009

(54) ARRANGEMENT FOR GENERATING A NON-LINEAR FORCE OR TORQUE CURVE

(75) Inventors: Steffen Braune, Wernigerode (DE); Klaus-Dietrich Kramer, Berga (DE)

Correspondence Address: NORRIS, MCLAUGHLIN & MARCUS, 875 THIRD AVE, 18TH FLOOR, NEW YORK, NY, 10022, US

(73) Assignee: INSTITUT FUR AUTOMATISIERUNG UND INFORMATIK GMBH, WERNIGERODE (DE)

(21) Appl. No.: 12/301,098

(22) PCT Filed: May 11, 2007
(86) PCT No.: PCT/DE07/00868

§ 371 Date: Nov. 17, 2008

(30) Foreign Application Priority Data
May 18, 2006 (DE) 10 2006 023 654.8

(51) Int. Cl. H02K 7/10; H01F 7/02; H02K 21/00

(52) U.S. Cl. 310/75 R; 335/306; 310/152

(57) ABSTRACT

The invention relates to an actuator device comprising a headpiece (1) with an adjuster mechanism for an actuating arm mounted to pivot on the headpiece into the actuated and open position and a housing (7) supporting the headpiece (1) with an interior for housing a linearly adjustable control rod connected to the adjuster mechanism (3) and connected to the actuator arranged in the housing (7). According to the invention, the housing (7) is in the form of an extrusion moulded hollow profile (8), the interior of which has a constant inner cross-section over the entire length thereof.

The invention relates to an arrangement for generating a nonlinear force or torque characteristic curve, which can be used in particular in systems for actuating gas exchange valves of internal combustion engines.

Conventional devices for actuating gas exchange valves rely on the spring support for opening and closing the valve (DE 103 58 936 A1; DE 103 11 275 A1; DE 101 40 461 A1). Spring support advantageously reduces the forces to be supplied by the valve actuator with electromagnetic actuation of gas exchange valves, which also reduces the electric energy dissipated by the actuators. The problem remains that the valve actuator must hold at the end positions against the force of the springs. More particularly, when using the “classic” valve spring, the spring must provide the required closing force for the valve, which necessitates large holding forces.

In particular, operating a rotary actuator which transmits its force to two or more valves via a double-sided pivoting lever requires a device which supports the opening process of all valves to be actuated.

Accordingly, it is an object to provide an arrangement which produces at the end positions of the valve motion a force for accelerating the valve, wherein only a small force or no force at all is produced beyond the position “valve closed.”

The object is attained by providing an arrangement for producing a nonlinear force and torque characteristic curve according to the features of the independent claim. Particularly advantageous embodiments of the arrangement are recited in the corresponding dependent claims.

According to a core aspect of the invention, the arrangement of the invention takes over the function of the opening springs, which are otherwise a typical component of electromagnetic valve actuators, and generates a very large force at a very small rotation (e.g., at the beginning of the valve opening)—starting from a center zero position of the rotor of the valve actuator where the supplied force is zero or approximately zero-, which decreases substantially linearly with further rotation.

Starting from the center zero position, this force is oriented so as to support the opening operation of the respective valve(s) for both right-handed and left-handed rotation.

In cooperation with the closing spring which is present in each valve, the arrangement operates as a spring-mass oscillator.

The invention will now be described with reference to an exemplary embodiment. The appended drawings show in:

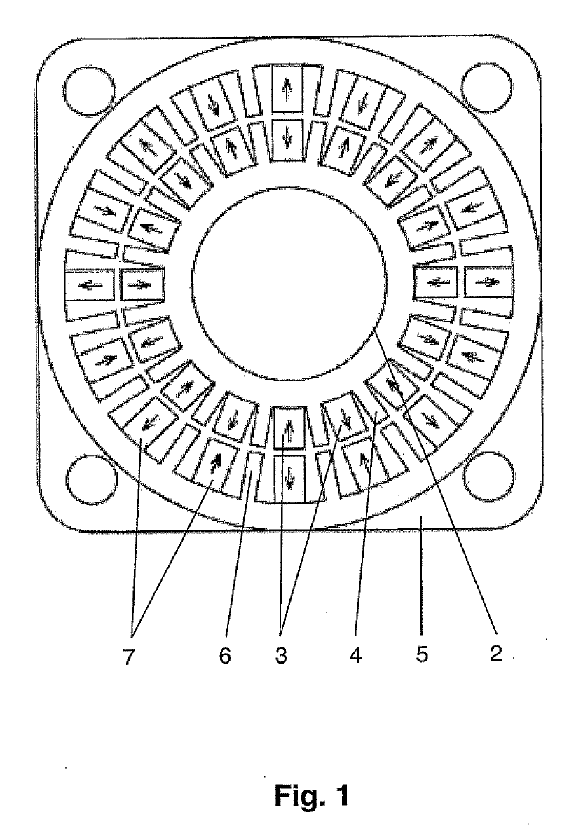

FIG. 1 a schematic diagram of the arrangement for generating a nonlinear force or torque characteristic curve,

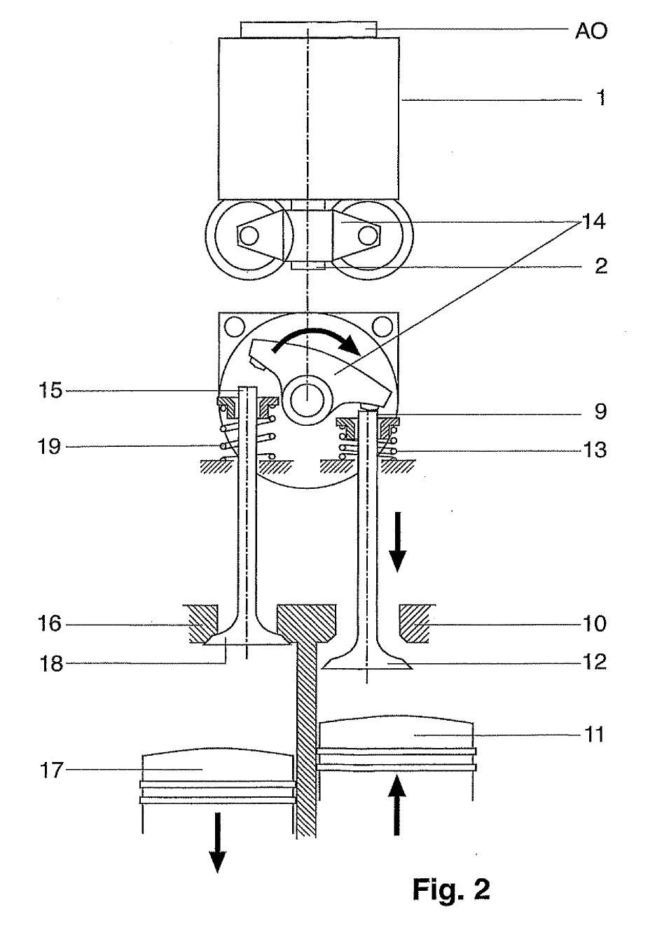

FIG. 2 a schematic diagram of a duplex arrangement for operating two valves of an intern in a combustion engine by using the arrangement of the invention for generating a nonlinear force or torque characteristic curve,

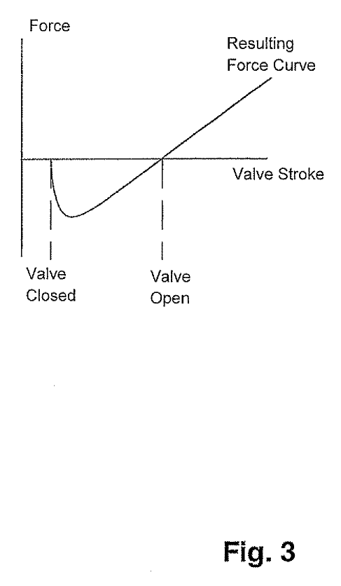

FIG. 3 a force curve during a valve stroke,

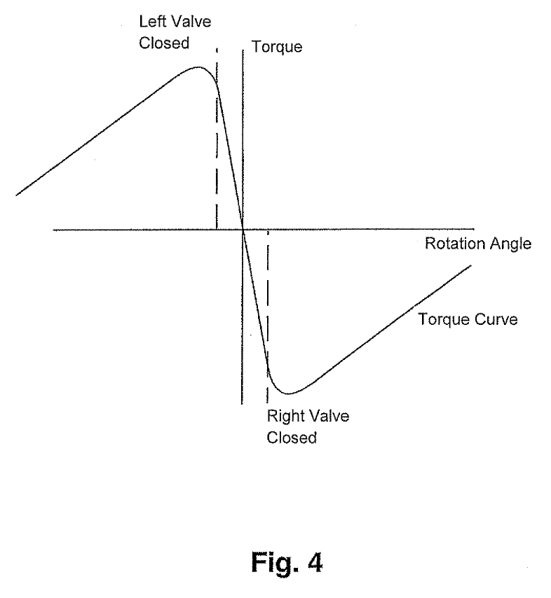

FIG. 4 a torque curve of a duplex arrangement for actuating two valves, and

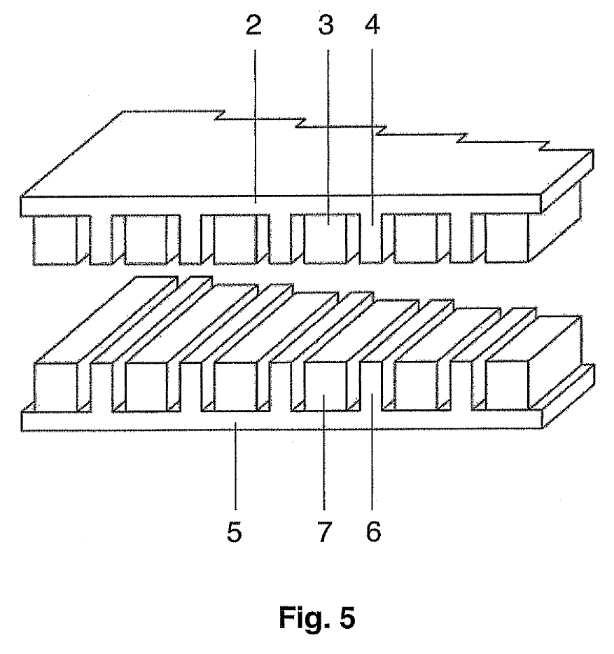

FIG. 5 a schematic flat projection of the particular design of poles and permanent magnet segments of rotor and stator of the arrangement of the invention for generating a nonlinear force and/or torque characteristic curve.

FIG. 1 shows an arrangement according to the invention for generating a nonlinear force and/or torque characteristic curve which includes an iron rotor with a rotor shaft 2 and alternatingly magnetized permanent magnets 3 as well as poles 4. A stator 5 assembled from magnetic sheet metal has poles 6, with alternatingly magnetized permanent magnets 6 arranged between the poles. Stator bores are used for attaching the arrangement of the invention for generating a nonlinear force and/or torque characteristic curve on a reluctance motor 1 of a rotary actuating device for gas exchange valves of an internal combustion engine.

FIG. 2 shows an arrangement AO for generating a nonlinear force and/or torque characteristic curve which is used with a rotary device for actuating two gas exchange valves 12 and 18 located in two cylinders 10 and 16 with pistons 11 and 17. The arrangement AO is flanged to the backside of a reluctance motor 1 and affects with its nonlinear force and/or torque characteristic curve the torque supplied by the reluctance motor 1. The rotor shaft 2 of the arrangement AO of the invention and the rotor shaft 2 of the reluctance motor 1 are constructed and connected in the longitudinal direction so as to essentially form a single unit.

A double-lever 14 is disposed on the rotor shaft 2 of the reluctance motor of the rotary device for operating two gas exchange valves, wherein the ends of the lever 14 apply the required, intentionally nonlinear operating forces to the respective valve stem ends 9 and 15 of the two gas exchange valves 12 and 18. The classic valve springs 9 and 19 provide the closing forces for the gas exchange valves 12 and 18.

The arrangement AO according to the invention for generating a nonlinear force and/or torque characteristic curve operates as follows, as shown in FIG. 3:

When the rotor shaft 2 is at the center position (torque=zero), the permanent magnet segments 3 of the rotor shaft and 7 of the stator 5 are positioned directly opposite one another, wherein the permanent magnet segments 3 and 7 facing each other are magnetized with opposite polarity. The magnetization with opposite polarity produces a torque for a small rotation due to the repulsion of the opposing permanent magnet segments 3 and 7, with a torque operating in the direction of the rotation. The rotation also causes a magnetic flux in the poles 6 of the stator 5 and the poles 4 of the rotor shaft 2, which in cooperation with the permanent magnet segments 3 and 7 which rotate towards the poles 4 and 6, produces a pulling force which operates in addition to the repulsive force that exists between the opposing permanent magnet segments 3 and 7. Further rotation produces an attractive force between the permanent magnet segments 7 of the stator 5 and the permanent magnet segments 3 of the rotor shaft 2, which have the same magnetization direction. These forces then attempt to minimize the air gap between the permanent magnet segments 3 and 7 and produce a torque in the aforementioned direction. When the rotor turns, the torque decreases to zero until the permanent magnet segments face each other.

In principle, the AO arrangement operates according to the invention even if no poles 4 and 6 are formed between the permanent magnet segments 7 of the stator 5 and the permanent magnet segments 3 of the rotor shaft 2. The resulting torque characteristic curve is approximately sinusoidal, as shown in FIG. 4, wherein the maximum of the torque is located near the center position (zero position). The maximum is then located at half the angle between the poles or between the permanent magnet segments.

The resulting torque with respect to right and left rotation can be designed to be asymmetric by making the overlap between the permanent magnet segments 3 of the rotor shaft 2 and the permanent magnet segments 7 of the stator 5, as well at between the poles of rotor shaft 2 and stator 5 different, depending on the rotation direction. The overlap can be made different by decreasing or increasing the installation depth of the permanent magnet segments 3 and 7, respectively, of the stator 5 and the rotor shaft 2, as well as the installation depth of the poles 6 and 4 of the stator 5 and the rotor shaft 2 from one permanent pole segment to another permanent pole segment, or from one pole to another pole. An exemplary embodiment is shown in FIG. 5 as a schematic flat projection.

The resulting force and/or torque characteristic curve illustrated in FIG. 4 is comparable with that of a conventional arrangement, where the spring is urged against a cam. If the cam is oriented perpendicular to the spring force, then the resulting torque on the shaft of the cam is zero. If the cam is rotated slightly, then the cam converts the spring force into a torque, which is very small for a small rotation, thereafter reaches a maximum, and decreases again with further rotation. Disadvantageously, such cam arrangement requires the high spring forces and accordingly a large friction between spring and cam. In addition, a desired characteristic curve where the maximum are located very close to the zero position (center position) is very difficult, if not impossible, to design (taking into account the available installation space).

The resulting curve illustrated in FIG. 4 is based on the cooperation between a classic valve spring and the arrangement AO according to the invention, which operate as a spring-mass oscillator.

The arrangement according to the invention for generating a nonlinear force and/or torque characteristic curve can also be implemented as a linear arrangement. The arrangement is here composed of a rotor having permanent magnet segments which are magnetized with alternating polarity, preferably perpendicular to the direction of movement, wherein iron poles can be formed between the magnet segments having different polarization. The stator, which is spaced from the rotor on both sides, is constructed of iron or a sheet metal laminate having ferromagnetic properties, and has on the side facing the rotor permanent magnet segments which are also alternatingly magnetized, preferably perpendicular to the direction of movement. Iron poles can be formed between the magnet segments with different polarization.

In another embodiment of the invention, the arrangement for generating a nonlinear force and/or torque characteristic curve includes a cylindrical rotor which performs a translation motion, wherein the stator is here arranged both inside and outside the rotor.

When the described embodiments of the invention are employed in valve controls, the valve actuator is assisted during the opening phase of the operated valves.

The arrangement according to the invention supplies in the end positions of the valve motion a force for accelerating the valves and, more particularly, applies only a small force or no force at all beyond the position “valve closed.”

In summary, the energy efficiency of the electromotive valve control can be significantly improved by employing the arrangement of the invention for generating a nonlinear force and/or torque characteristic curve.

### LIST OF REFERENCE SYMBOLS AND FORMULA SYMBOLS

AO arrangement for generating a nonlinear force and/or torque characteristic curve

1 reluctance motor

2 rotor shaft

3 permanent magnet segment (of the rotor shaft)

4 pole

5 stator

6 pole

7 permanent magnet segment (of the stator)

9 valve stem end

10 cylinder

11 piston

12 gas exchange valve

13 valve spring

14 double-lever

15 valve stem end

16 cylinder

17 piston

18 gas exchange valve

19 valve spring

1-11. (canceled)

12. An arrangement for generating a nonlinear force and/or torque characteristic curve, comprising
a cylindrical iron rotor (2) and a stator (5),
the cylindrical iron rotor 2) having a periphery,
permanent magnet segments (3) alternatingly magnetized in opposite directions and forming poles, arranged on the periphery of the cylindrical iron rotor (2),
the stator (5) made of iron or a magnetic sheet metal laminate and having on its inner circumference permanent magnet segments (7) alternatingly magnetized in opposite directions and forming poles, and
iron poles (4; 6) are provided between the permanent magnet segments of the rotor (2) and/or stator (5) having different polarization.

2. The arrangement according to claim 1,
wherein an average angle between two alternatingly magnetized permanent magnet segments (3) of the rotor (2) corresponds to an average angle between two alternatingly magnetized permanent magnet segments (7) of the stator (5).

3. The arrangement according to claim 2,
wherein the iron poles (4; 6) are in form of cuboids having exclusively rectangular boundary surfaces.

4. The arrangement according to claim 2,
wherein the iron poles (4; 6) are in form of cuboids with partially trapezoidal or triangular boundary surfaces.

5. The arrangement according to claim 2,
wherein for an asymmetric design of a resulting rotation-direction-dependent torque for a right-hand and left-hand rotation, an overlap of the permanent magnet segments (3) of the rotor (2) and of the permanent magnet segments (7) of the stator (5) is different.

6. The arrangement according to claim 5,
wherein for a different overlap, an installation depth of the permanent magnet segments (3; 7) of stator (5) and rotor (2), as well as the installation depth of the poles (6; 4) of stator (5) and rotor (2), are decreased or increased from one permanent magnet segment (3; 7) to another permanent magnet segment (3; 7) or from one pole (4; 6) to another pole (4; 6).
